(19) United States
(12) Patent Application Publication
(10) Pub. No.: US 2007/0298200 A1
(43) Pub. Date: Dec. 27, 2007

(54) HOLLOW MOULDED PART AND METHOD FOR MANUFACTURING A HOLLOW MOULDED PART

(75) Inventor: Hartwig Muller, Chemnitz (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: Automotive Group ISE Innomotive Systems

(21) Appl. No.: 11/756,752

(22) Filed: Jun. 1, 2007

(30) Foreign Application Priority Data
Jun. 2, 2006 (EP) 06011530.0

(51) Int. Cl. B32B 27/08; B60R 21/16

(52) U.S. Cl. 428/36.1; 428/35.7

(57) ABSTRACT

A hollow moulded part 16′ made from plastic material containing fibres has at least two hollow chambers 6, 7, 8 between which at least one web 15s provided which bounds the hollow chambers together with outer wall parts 2, 3. The hollow moulded part 16′ is a one piece pressed moulded part 1 of a fibre compound plastic material K containing endless fibres in a plastic material matrix. The web 15 also contains endless fibres 14a or 14b. The endless fibres 14a directly extend between the outer wall parts 2, 3 around the hollow chambers 6, 7, 8. The endless fibres 14b are displaced from each other wall part 2, 3 into the web 15 and are anchored to each other.

### CROSS REFERENCE TO RELATED APPLICATION(S)

This application claims the benefit of EP 06011530, filed on Jun. 2, 2006, which is hereby incorporated by reference in full.

### BACKGROUND OF THE INVENTION

This invention relates to a hollow moulded part of plastic material containing endless fibers.

This invention further relates to a method for producing pressed moulded parts of fiber compound plastic material containing endless fibers within a multi-part pressing mould under suitable pressure and temperature conditions.

Pressed moulded parts made from fibre composite plastic material containing endless fibres have gained increasing importance for e.g. the manufacturing of automobiles because such hollow moulded pans have an extremely low weight but perform with excellent strength and deformation properties. When manufacturing such parts so-called prepregs are laid in a pressing mould, in some regions several layers on top of each other, which prepregs then are plasticized with the help of high temperature and finally are pressed into the final shape. The prepregs e.g. contain a fabric of endless glass fibres including weft yarns and warp yarns, and an impregnation of thermoplastic plastic material. These pressed moulded parts with a view to expected future loads can be made unitarily e.g. with inbuilt reinforcing fins, reinforcements or the like, until now however could not be made with hollow chambers of considerably larger dimensions.

Rollover protection bodies for automotive rollover protection devices exist which bodies respectively contain at least one hollow chamber and consist of two joined jacket shaped pressed moulded parts of fibre compound plastic material. These hollow moulded parts are relatively flat, i.e., the thickness dimension is substantially smaller than the width and the length. When being used as a rollover protection body the joined hollow moulded part is loaded in case of vehicle rollover crash predominantly in the X-direction of the vehicle body (direction of the longitudinal axis of the vehicle). In this situation it is important to achieve an extremely effective efficient shear interlock in the joining area between the bowl-shaped pressed bodies. In order to improve the properties of the shear interlock the bowl-shaped pressed moulded parts are connected along contacting edges and in some cases also in the interior region by mechanical connection elements. The properties of the shear interlock in this case depend among other things on the friction contact and the interlock between the bowl-shaped pressed moulded parts, however, are limited by this joining technique. For these reasons the pressed moulded parts e.g. are reinforced with a view to future loads which means that the entire weight of the pressed moulded parts becomes relatively high.

Furthermore, a conventional rollover protection device for a vehicle body of a convertible automobile is known which extends like an arcuated targa bracket over the open side of the vehicle body. The bracket is formed from fibre compound plastic material pressed moulded parts having a generally wave-shaped cross-section and being joined by mechanical connection elements such that channel-like hollow chambers are defined which extend along the longitudinal extension of the bracket. Reinforcing elements may be inserted into the hollow chambers which reinforcing elements at the same time may be used as mould cores when shaping the pressed moulded bodies.

Furthermore, it is known to produce fibre reinforced plastic hollow moulded parts by injection moulding. Injection moulding, however, only allows to process plastic material which contains very short fibres or fibres the length of which is significantly restricted. Such hollow moulded parts cannot be used in case of high standards, e.g. in automotive engineering, because the inner force taking up property of the material is too limited.

### SUMMARY OF THE INVENTION

It is an object of the invention to provide a hollow moulded part and a method for manufacturing a hollow moulded part allowing to achieve an excellent interior shear interlock and by this an improved capability to take up forces and such that less compound plastic material is needed in the outer wall regions in order to save weight. A part of the object is to provide a method for manufacturing such hollow moulded parts which method is adapted to the given possibilities when working with prepregs containing endless fibres in comparison to the possibilities of injection moulding.

As according to claim 1 the outer wall parts directly are interconnected via endless fibres extending around the hollow chambers an extremely efficient interior shear interlock is achieved against loads which are directed substantially perpendicular to the outer wall parts. An additional advantage is that if any, only a few mechanical connection elements are needed which simplifies the manufacturing process. Thanks to the excellent interior shear interlock, less material in the wall parts, and because mechanical connection elements either can be dispensed with or are needed only in a small number a significant weight saving is achieved while the usage properties are improved in comparison to externally equally dimensioned conventional hollow moulded parts. The load usage property of such a hollow moulded part used as a rollover protection body e.g. can be improved up to 60% in the X-load direction compared to conventional hollow moulded parts made from fibre compound plastic material.

According to claim 2 also a very efficient interior shear interlock against loads directed substantially perpendicular to the outer wall parts is achieved by a cogging of form-fit elements provided between the web sections. This saves weight even for hollow moulded parts fulfilling the highest load requirements. The formation of the form-fit elements uses the restricted possibility when working with prepregs and pressing the prepregs in a plasticized stated, e.g. in particular in view of a displacement of endless fibres into the thus reinforced form-fit elements.

When implementing the methods of claims 11 and 12 unitary hollow moulded parts can be provided which have a very efficient interior shear interlock, by using the restricted possibilities of working with prepregs, such that the hollow moulded parts are able to withstand high loads later. The respective mould core does not define the hollow chamber but also consists of a material flow guiding surface for properly displacing and positioning the endless fibres which result in a significant improvement of the force resisting properties in the later hollow moulded part.

In order to achieve an efficient shear interlock in the unitary hollow moulded part not only in the web between the hollow chambers in an expedient embodiment also in the respective joining region of two edge portions the shear interlock is improved by endless fibres which directly extend between the edge portions or by endless fibres which are displaced from each edge portion into the joining region and which displaced endless fibres are anchored to each other. Hardly any mechanical connection elements are needed in such edge regions containing the fibres.

In an expedient embodiment of the hollow moulded part consisting of two joined bowl-shaped pressed moulded parts mutually cogged form-fit elements are provided in the edge portion in order to also improve the shear interlock in these areas.

In an expedient embodiment the form-fit elements are put within each other substantially perpendicular to the joining area. In this case, preferably, the form-fit elements may be depressions and projections fitted into the depressions. The forces acting between the outer wall parts in different directions then efficiently are transmitted by the improved shear interlock at several locations and via large areas.

In another embodiment of the hollow moulded part consisting of two bowl-shaped, joined pressed moulded parts the form-fit elements are put into each other substantially parallel to the joining area. Exactly in this direction, however, the shear interlock then is less efficient, however, in all other directions and substantially perpendicular to the joining area the shear interlock then is extremely efficient. Since the form-fit elements also hold the outer wall parts together, mechanical correaction elements can be dispensed with to a large extent. Expediently, the form-fit elements are dovetail-like depressions and hook-shaped projections fitted into these depressions, because these shapes can be formed without problems when working with prepregs and when pressing the plasticized prepregs. The direction along which the form-fit elements are put within each other is selected with a view to future loads such that the shear interlock which is weaker in one direction does not create a drawback.

Expediently, in the latter-mentioned case end stops are formed in the depressions and/or at the hook-shaped projections to limit the depth with which the form-fit elements can be put into one another. Furthermore, then both pressed moulded parts will become positioned accurately in relation to each other, and mechanical connection elements can be dispensed with. If, however, the joint has to be assisted by connection elements, in this case gluing or other usual mechanical connections used in this area can be used, the number of which can then be very small.

Expediently, each pressed moulded part is produced from prepregs which contain endless glass fibre fabric and which are impregnated with plastic material like polypropylene. Such prepregs are available on the market in a large variety of specifications. For particularly high duty applications it may even be useful to use better quality fibre material like carbon fibres or aramid fibres, or the like. Polypropylene, when used as the thermoplastic impregnation material for later forming a plastic material matrix within which the endless fibres are anchored in the final product has particularly advantageous properties in view of e.g. resilience or the like.

The respective hollow moulded part expediently is a rollover protection body for a vehicle rollover protective device. The hollow moulded part is characterised by an extremely efficient interior shear interlock specifically in case of loads acting substantially perpendicular on the outer wall parts. However, the use of such hollow moulded parts should not be limited to this area, but there may be other applications accompanied by loads needing a correspondingly efficient take up of forces.

The methods are particularly well suited for manufacturing rollover protection bodies from fibre compound plastic material for automotive rollover protection devices because the method, when using the possibilities existing when working with prepregs, results in a very efficient interior shear interlock within the web and in some cases also in the edge regions.

### BRIEF DESCRIPTION OF THE DRAWINGS

Embodiments of the invention will be explained with the help of the drawings.

FIG. 1 is a cross-section of a unitary hollow moulded part made from fibre compound plastic material in a pressing mould,

FIG. 2 is a cross-section of another unitary hollow moulded part made from fibre compound plastic material, already removed from the pressing mould,

FIG. 3 is perspective views of two bowl-shaped press moulded parts made from fibre compound plastic material intended for manufacturing a hollow moulded part,

FIGS. 4 and 5 are two pressed moulded parts made from fibre compound plastic material, which belong to each other in order to produce a hollow moulded part,

FIGS. 6 and 7 are views of the pressed moulded parts of FIGS. 4 and 5 in viewing direction from the left side in FIGS. 4 and 5, and

FIG. 8 is the final hollow moulded part consisting of the joined pressed moulded parts, in the same viewing direction as in FIGS. 6 and 7.

### DETAILED DESCRIPTION OF THE PREFERRED EMBODIMENT(S)

A hollow moulded part 1 made from fibre compound plastic material K containing endless fibres 14, 14a is produced in a pressing mould W including tipper and lower pressing mould halves 9, 10 which commonly define a mould cavity. The method is carried out with the help of prepregs which are laid into the pressing mould W and by applying pressure and temperature until the fibre compound plastic material K is produced. The prepregs e.g. contain a fabric made of endless glass fibres with weft yarns and warp yarns and a plastic material impregnation, e.g. consisting of thermoplastic propylene. The prepregs are laid in some cases in several layers and with a volume by which after plasticization of the plastic material and intended displacement of endless fibres the mould cavity will be completely filled.

The unitarily formed hollow moulded part 1 is a pressed moulded part 16′ consisting of the fibre compound plastic material K and has outer wall parts 2, 3 which are distant from each other and substantially parallel to each other. Furthermore, in the pressed moulded part 16′ the outer wall parts 2, 3 are joined to each other via endless fibres in edge portions 4, 5 and in a respective web 15 between hollow chambers 6, 7, 8. The hollow chambers 6, 7, 8 are formed by mould cores 11, 12 and 13 which either are laid into the pressing mould W or are a part thereof. Expediently, the hollow moulded part 1 is open at one end and is closed at the other end.

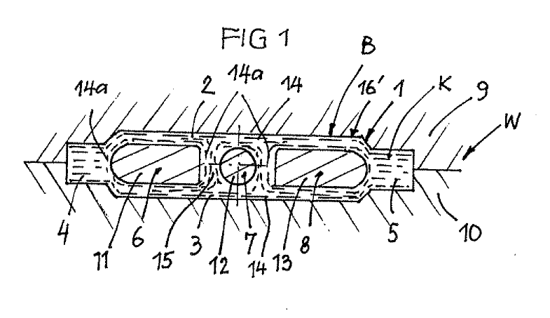

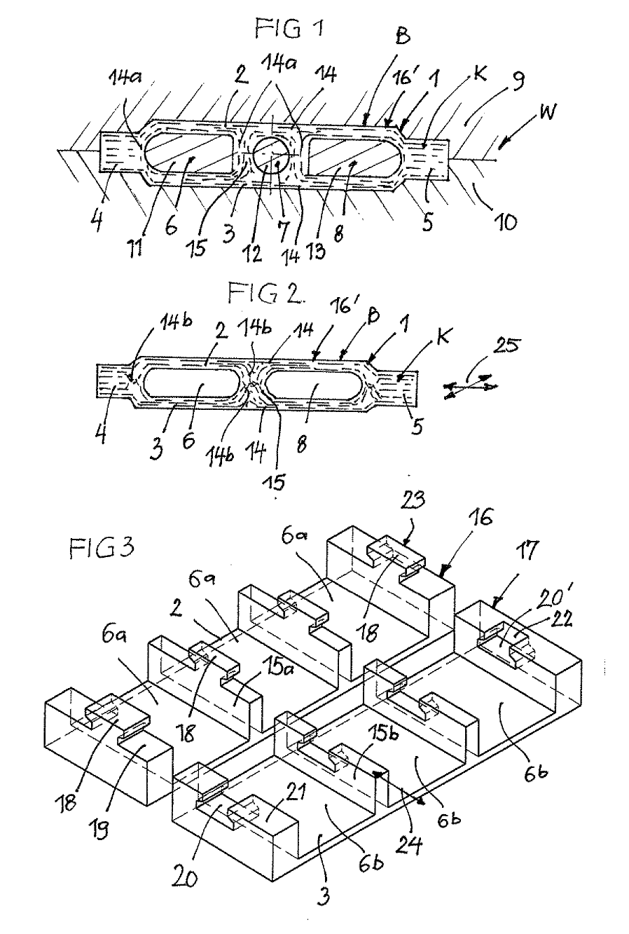

The hollow moulded part 1 as show in FIG. 1 is characterised in that endless fibres 14a continuously extend around the hollow chambers 7, 8 and there directly connect the outer wall parts 2, 3 with each other. Those endless fibres 14a either belong to the endless fibres 14 in the outer wall parts 2, 3 or are provided additionally. The endless fibres extending around the hollow chambers 6, 7, 8 can either only be present in the sections of the mould cavity which defines the webs 15, or may, as shown, also be present in the edge portions 4, 5. In this fashion an efficient interior shear interlock is achieved on one side within the webs 15, and in some cases also in the edge regions 4, 5. The outer wall parts 2, 3 are firmly joined to each other, such that, in some cases, no further mechanical connection elements are needed. In order to place the endless fibres 14a such into the web 15, one or several prepregs (which are available in a flexible planar shape) are laid around each mould core 11, 12, 13, in some cases such that they overlap prepregs situated into the outer wall parts 2, 3, and, in some cases even overlap each other.

In FIG. 1 a total of three hollow chambers 6, 7, 8 is provided. The hollow chambers 6, 8 situated at the outer sides extend longitudinally and show an oval cross-section, while the central hollow chamber 7 has a round cross-section. The cross-sections of the hollow chambers provided, however, may be selected arbitrarily.

The embodiment of the unitary hollow moulded part 1 consisting of fibre compound plastic material K in FIG. 2 contains in the pressed moulded part 16′ two hollow chambers 6, 8 which have substantially equal cross-sections and a single web 15 in-between. In comparison to the embodiment of FIG. 1 in FIG. 2 endless fibres 14b respectively are displaced from the side of the outer wall parts 2, 3 into the web 15, which endless fibres 14b are provided in addition to the endless fibres 14 in the outer wall parts 2, 3. The endless fibres 14b are displaced so far into the web 15 that they, preferably, overlap each other and form a load carrying interlock in the plastic material matrix. Endless fibres 14b which are displaced in part around the hollow chambers 6, 8 also may be provided in the edge portions 4, 5. The interior efficient shear interlock withstands, in particular, forces which may develop in the directions as indicated by the double arrows 25 between the outer wall parts 2, 3 in the web 15, and, in some cases, in the edge portions 4, 5, when the hollow moulded part 1 underlies and external load, e.g. in directions substantially perpendicular to the outer wall parts 2 or 3.

The hollow moulded parts 1 of FIGS. 1 and 2 expediently are rollover protection bodies (rollover bars) for automotive rollover protection devices, which rollover protection bodies either are mounted stationarily or extendably in an automobile. In some cases the hollow chambers 6, 7, 8 then may be used for installing therein of assemblies needed for the function or operation of the rollover protection devices.

FIG. 3 indicates an embodiment in which a hollow moulded part is made from two bowl-shaped pressed moulded parts 16, 17, respectively of fibre compound plastic material. These two pressed moulded parts 16, 17 are joined in a special way and may, in some cases, additionally be fixed to each other by gluing or with the help of not shown mechanical connection elements.

Respective web sections 15a or 15b are integrally formed at the outer wall parts 2, 3. The web sections 15a and 15b define joining surfaces 19, 21 and form-fit elements 18, 20 which respectively fit into each other. The form-fit elements in the pressed moulded part 16 are hook-shaped projections 18 (T-shaped) which are aligned to each other in longitudinal direction. Hollow chamber partial sections 6a are defined between the web sections 15a. The projection 18 shown in FIG. 3 at the extreme right side position at the pressed moulded part 16 has a front side stop surface 23.

The other pressed moulded part 17 fitting to the pressed moulded part 16 also has integrally formed web sections 15b between which hollow chamber partial regions 6b are defined. The form-fit elements 20 of the pressed moulded part 17 are dovetail-like depressions into which, when joining both pressed moulded parts 16, 17 to produce the hollow moulded part, the projections 18 are shifted in or inserted in a cogging fashion until the stop surface 23 abuts at a stop surface 22 of the depression (form-fit element 20′) shown in FIG. 3 on the right side of the pressed moulded part 17. Both pressed moulded parts 16, 17 are made unitarily from fibre compound plastic material, and such that endless fibres which are not shown in the figure are contained in the web sections 15a, 15b, in the form-fit elements 18,20, and in the outer wall parts 2, 3, respectively.

The hollow-shaped part made from the pressed moulded parts 16, 17 is characterised by an efficient shear interlock mainly against loads or forces acting in the direction of the double arrow 24.

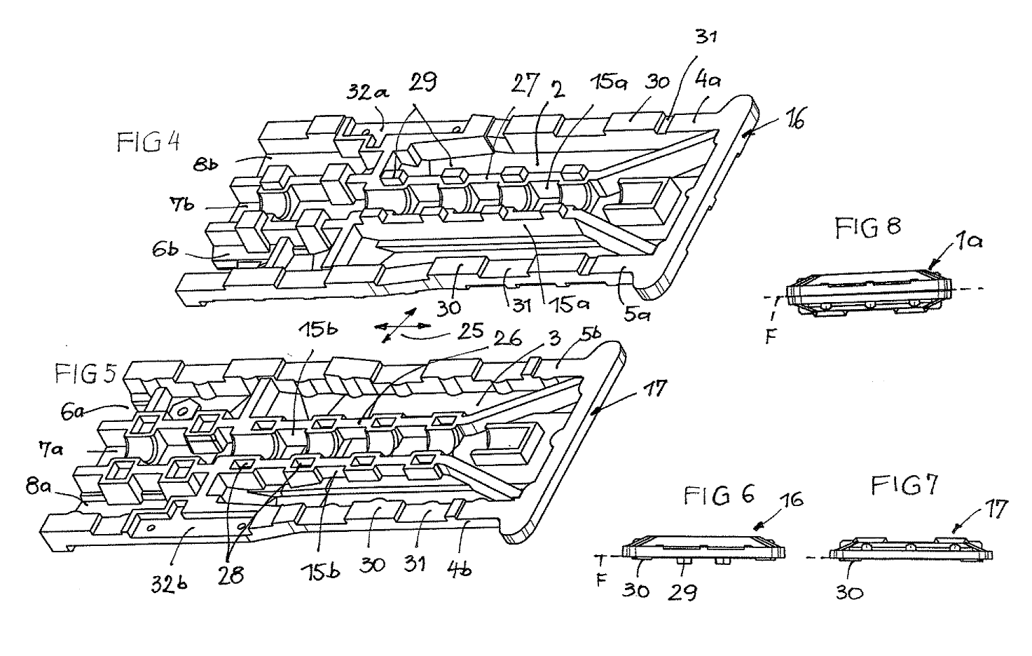

FIGS. 4 and 5 show two integral pressed moulded parts 16, 17 consisting of fibre compound plastic material, both fining to each other, from which a hollow moulded part 1a according to FIG. 8 is produced having in a substantially planar joining region F.

The pressed moulded part 16 has web sections 15a and protruding edge portions 4a, 5a adjacent to the outer wall part 2. Hollow chamber partial regions 6b, 7b, 8b are defined therebetween substantially analogously to FIG. 1. Form-fit elements 29 with the shape of block-like protruding projections are integrally formed at the web sections 15a which in turn are formed integrally with the outer wall part 2. The form-fit elements 29 are provided with intermediate distances and are distributed along the longitudinal extension of the web sections 15a. Expediently, form-fit elements 30, 31 with the shape of block-like projections and block-like depressions are integrally formed also at the edge regions 4a, 5a, and such that in these regions endless fibres of the fibre compound plastic material also are displaced into the form-fit elements 29, 30, 31. A recess 32a additionally is formed at the edge side which recess 32a e.g. may serve for later mounting a detent rail.

The other pressed moulded part 17 which fits to the pressed moulded part 16 has form-fit elements 28 which fit to the projections and which are depressions in the web sections 15b of the outer wall part 3. Furthermore, form-fit elements 30, 31 with the shape of block-like projections and block-like depressions are formed at the edge portions 5b, 4b.

FIGS. 6 and 7 show both pressed moulded parts 16, 17 respectively in a viewing direction of the joining area F on the front side situated in FIGS. 4 and 5 at the right side. FIGS. 6 and 7 show that form-fit element 29 and/or 30 protrude from the plane of the joining area F.

After the production of both pressed moulded parts 16, 17 in different pressing moulds the pressed moulded parts 16, 17 are joined in the joining area F to the final hollow moulded part 1a as indicated in FIG. 8. The hollow moulded part 1a may then be used as a rollover protection body (rollover bar) for an automotive rollover protection device. The hollow moulded part 1a is closed at the shown front side and along the edge regions and is open at one end (in the plane of the drawing) to the hollow chambers which are defined by the combined hollow chamber partial regions 6a, 6b, 7a, 7b, 8a, 8b. The pressed moulded part 17 also has a recess 32b for a detent rail in an edge side. Mechanical connection elements, e.g. tensioning screws or rivets e.g. may be mounted in the edge regions of the hollow moulded part 1a. Alternatively, both pressed moulded parts 16, 17 may be fixed to each other by gluing. In the hollow moulded part 1a an efficient interior shear interlock for taking up forces is achieved, which forces e.g. may act in different directions as indicated by the double arrows 25.

We claim:

9. Hollow moulded part according to claim 1, characterised in that the pressed moulded parts (1, 16, 17) is produced from prepregs in a multipart press mould (W), the prepregs containing glass fibre fabric being impregnated with plastic material like polypropylene.

10. Hollow moulded part according to claim 1, characterised in that the hollow moulded part (1, 1a) is a rollover protection body (B) for a vehicle rollover protection device.

13. Method according to claim 11, characterised in that a rollover protection body (B) or a vehicle rollover protection device is produced as the hollow moulded part (1).

14. Hollow moulded part according to claim 2, characterised in that the pressed moulded parts (1, 16, 17) is produced from prepregs in a multipart press mould (W), the prepregs containing glass fibre fabric being impregnated with plastic material like polypropylene.

15. Method according to claim 12, characterised in that a rollover protection body (B) or a vehicle rollover protection device is produced as the hollow moulded part (1).

16. Hollow moulded part according to claim 2, characterised in that the hollow moulded part (1, 1a) is a rollover protection body (B) for a vehicle rollover protection device.
